(19) United States
(12) Patent Application Publication
(10) Pub. No.: US 2015/0324815 A1
(43) Pub. Date: Nov. 12, 2015

(54) SEASONALITY-BASED REPORTING PERIOD SYNCHRONIZATION

(71) Applicant: Google Inc., (US)

(72) Inventors: Lucas Visvikis Pettinati, San Jose, CA (US); Doug Fox, Morgan Hill, CA (US); James Edward Stewart, Mountain View, CA (US); Daniel Steven Jukes, San Francisco, CA (US)

(73) Assignee: Google Inc., Mountain View, CA (US)

(21) Appl. No.: 13/870,677

(22) Filed: Apr. 25, 2013

Related U.S. Application Data
(60) Provisional application No. 61/787,149, filed on Mar. 15, 2013.

(51) Int. Cl. G06Q 30/02

(52) U.S. Cl. CPC G06Q 30/0202

(57) ABSTRACT

An automated computer-implemented method for generating a time-based comparative report is provided. The method includes receiving a selection of a first time period from a user device, identifying a first seasonality characteristic of the first time period, determining a second time period such that the second time period has a second seasonality characteristic matching the first seasonality characteristic, receiving from one or more data storage devices a first data set defined by the first time period and a second data set defined by at least one of the second time period and a user-selected third time period, and generating a comparative report using the first data set and the second data set.

### CROSS-REFERENCE TO RELATED APPLICATIONS

The present application claims the benefit of and priority to U.S. Provisional Patent Application No. 61/787,149 filed Mar. 15, 2013, the entirety of which is hereby incorporated by reference.

### BACKGROUND

The Internet provides access to a wide variety of content. Content providers such as advertisers and website operators often use a content management system to provide relevant content to a user device. The content management system may allow content providers to monitor the performance of various content items, analyze website traffic, or review the effectiveness of various content distribution strategies.

For these and other purposes, the content management system may generate a detailed report relating to a selected performance metric (e.g., a click through rate, a keyword value, a number of unique visitors, etc.). The report may compare the performance metric during a first time period with the same performance metric during a second time period. However, such comparative reports are often misleading due to qualitative differences between the first and second time periods. Selecting appropriate time periods such that the comparative reports express meaningful data is often challenging.

### SUMMARY

One implementation of the present disclosure is an automated computer-implemented method for generating a time-based comparative report. The method includes receiving a selection of a first time period from a user device, identifying a first seasonality characteristic of the first time period, determining a second time period such that the second time period has a second seasonality characteristic matching the first seasonality characteristic, receiving from one or more data storage devices a first data set defined by the first time period and a second data set defined by at least one of the second time period and a user-selected third time period, and generating a comparative report using the first data set and the second data set.

In some implementations, the first seasonality characteristic and the second seasonality characteristic are time-based qualities of the first and second time periods. For example, the first seasonality characteristic and the second seasonality characteristic may relate to at least one of: a time of day, a day of the week, a date, a month, and a year. In some implementations the first seasonality characteristic and the second seasonality characteristic describe a beginning of the first and second time periods. In some implementations, the first time period defines a particular day and the second time period defines a matching day from a previous week, a matching day from a previous month, or a matching day from a previous year. In some implementations, the first time period defines a range of days and the second time period defines a matching range of days from a previous week, a matching range of days from a pervious month, or a matching range of days from a previous year.

In some implementations, the method further includes providing an option to use either the second time period or the third time period for defining the second data set, receiving a selection of the third time period from a user device, identifying a third seasonality characteristic of the third time period, and providing a notification for display via the user device in response to the third seasonality characteristic not matching the first seasonality characteristic.

In some implementations, the method further includes receiving a selection of the third time period from a user device, determining the second time period based on the third time period and the seasonality characteristic of the first time period, providing a selectable preview of the second time period for display via the user device, and using the second time period for defining the second data set in response to a selection of the selectable preview of the second time period. In some implementations, the selectable preview of the second time period includes a description of the seasonality characteristic of the second time period.

In some implementations, the method further includes generating a list of selectable time periods and providing the list of selectable time periods for display via the user device. At least one of the first time period, the second time period, and the third time period may be selected from the list of selectable time periods.

Another implementation of the present disclosure is one or more non-transitory computer-readable media having instructions stored therein, the instructions being executable by one or more processors to cause the one or more processors to perform operations including receiving a selection of a first time period from a user device, identifying a first seasonality characteristic of the first time period, determining a second time period such that the second time period has a second seasonality characteristic matching the first seasonality characteristic, receiving from one or more data storage devices a first data set defined by the first time period and a second data set defined by at least one of the second time period and a user-selected third time period, and generating a comparative report using the first data set and the second data set.

In some implementations, the first seasonality characteristic and the second seasonality characteristic are time-based qualities of the first and second time periods. For example, the first seasonality characteristic and the second seasonality characteristic may relate to at least one of: a time of day, a day of the week, a date, a month, and a year. In some implementations the first seasonality characteristic and the second seasonality characteristic describe a beginning of the first and second time periods. In some implementations, the first time period defines a particular day and the second time period defines a matching day from a previous week, a matching day from a previous month, or a matching day from a previous year. In some implementations, the first time period defines a range of days and the second time period defines a matching range of days from a previous week, a matching range of days from a pervious month, or a matching range of days from a previous year.

In some implementations, the instructions further cause the one or more processors to perform operations including providing an option to use either the second time period or the third time period for defining the second data set, receiving a selection of the third time period from a user device, identifying a third seasonality characteristic of the third time period, and providing a notification for display via the user device in response to the third seasonality characteristic not matching the first seasonality characteristic.

In some implementations, the instructions further cause the one or more processors to perform operations including receiving a selection of the third time period from a user device, determining the second time period based on the third time period and the seasonality characteristic of the first time period, providing a selectable preview of the second time period for display via the user device, and using the second time period for defining the second data set in response to a selection of the selectable preview of the second time period. In some implementations, the selectable preview of the second time period includes a description of the seasonality characteristic of the second time period.

In some implementations, the instructions further cause the one or more processors to perform operations including generating a list of selectable time periods and providing the list of selectable time periods for display via the user device. At least one of the first time period, the second time period, and the third time period may be selected from the list of selectable time periods.

The foregoing is a summary and thus by necessity contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a block diagram of a computer system which may be used to automatically define one or more time periods and generate a comparative content performance report based on content performance data defined by the one or more time periods, the computer system including a network, content providers, resources, user devices, a content management system, and data storage devices, according to a described implementation.

FIG. 2 is a block diagram illustrating in greater detail the content management system of FIG. 1, according to a described implementation.

FIG. 3 is a flowchart of a process for automatically define one or more time periods and generating a comparative content performance report based on content performance data defined by the one or more time periods, according to a described implementation.

FIGS. 4A-4D are drawings of a user interface for defining the one or more time periods, the user interface including several time period selection options and a comparison button for toggling a comparison window, according to a described implementation.

FIGS. 5A-5C are drawings of another user interface for defining the one or more time periods, the user interface including several options for selecting a first time period and multiple groups of selectable options for defining a second time period based on the selection of the first time period, according to a described implementation.

### DETAILED DESCRIPTION

Referring generally to the FIGURES, systems and methods for automated reporting period selection and components thereof are shown and described. The systems and methods described herein may be used to automatically determine a time period for use in a time-based comparative report. For example, a content provider (e.g., an advertiser, a website operator, etc.) may desire to compare a content performance metric (e.g., a click through rate, a number of conversion events, a keyword value, website traffic, etc.) during a first time period with the same content performance metric during a second time period (e.g., to evaluate content performance over time, to assess the effectiveness of an experimental content distribution strategy, etc.). The content provider may use a content management system to generate a report comparing the content performance metric during the first and second time periods.

If the first and second time periods are not appropriately selected, the data in the comparative report may be misleading. For example, a content provider may routinely experience a higher number of conversion events (e.g., online product sales or other events satisfying conversion criteria) during the weekend than during the week. Accordingly, a report comparing the number of conversion events during a Friday-Sunday period with the number of conversion events during a Monday-Wednesday period may be misleading regarding the effectiveness of a newly-implemented content distribution strategy (e.g., beginning on the Monday of the second time period).

Advantageously, the systems and methods described herein may automatically determine an appropriate reporting period (e.g., the first time period and/or the second time period) such that the first and second time periods have similar or matching “seasonality characteristics.” A seasonality characteristic may be a time-based quality of a given time period. For example, a seasonality characteristic may relate to a time of day (e.g., between 4:00 P.M. and 6:00 P.M.), a day of the week (e.g., Monday, Wednesday, Saturday, etc.), a month, a year, a date, a range of dates, or any other time-based attribute of a given time period.

In some implementations, a selection of a first time period may be received from a user device. The systems and methods of the present disclosure may identify a seasonality characteristic of the first time period and automatically determine a second time period having a matching seasonality characteristic (e.g., a same number of weekdays and weekend days, a same range of dates from a pervious year, etc.). The first and second time periods may be used to define a first data set and a second data set to be compared and/or presented to the content provider in the time-based comparative report.

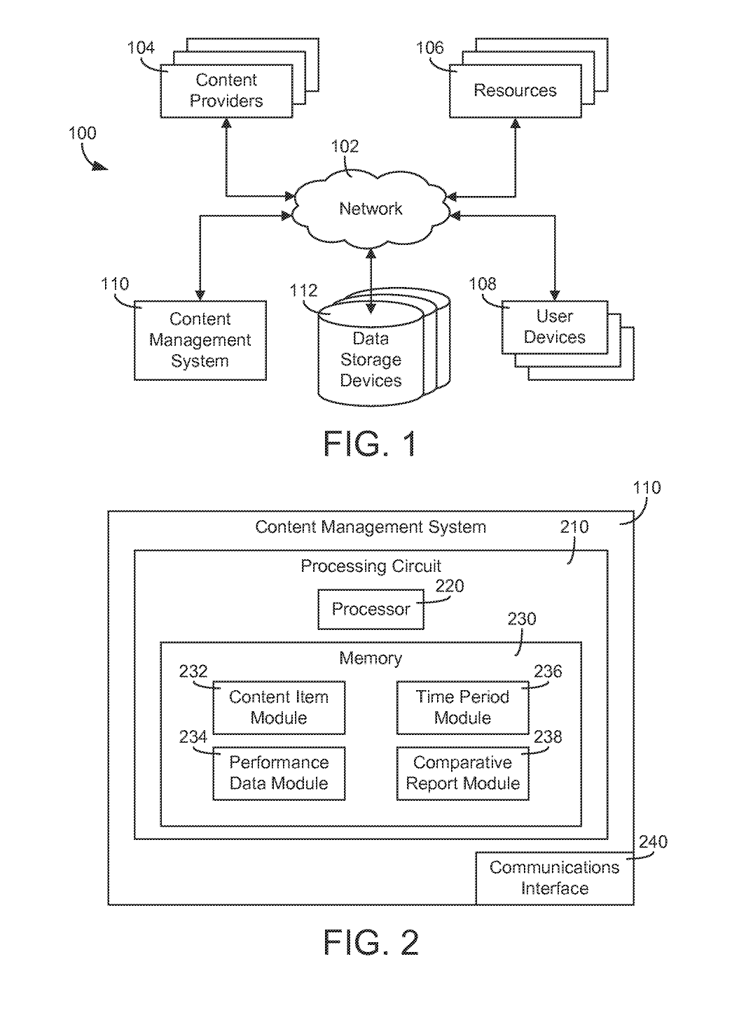

Referring now to FIG. 1, a block diagram of a computer system 100 is shown, according to a described implementation. Computer system 100 is shown to include a network 102, content providers 104, resources 106, user devices 108, a content management system 110, and data storage devices 112. Computer system 100 may facilitate communication between content providers 104, resources 106, and user devices 108. For example, a content item provided by content providers 104 may be presented to user devices 108 via network 102. The content item may be displayed in a content slot of resources 106 along with other content comprising resources 106.

Computer system 100 may also facilitate communication between content providers 104, content management system 110, and data storage devices 112. For example, content management system 110 may receive a request to generate a comparative report from content providers 104 via network 102. Content management system 110 may receive content performance data from data storage devices 112 and generate the comparative report based on such data. The comparative report may then be communicated to content providers 104 via network 102.

Network 102 may include any type of computer network such as local area networks (LAN), wide area networks (WAN), cellular networks, satellite networks, radio networks, the Internet, or any other type of data network. Network 102 may include any number of computing devices (e.g., computers, servers, routers, network switches, etc.) configured to transmit, receive, or relay data. Network 102 may further include any number of hardwired and/or wireless connections. For example, content providers 104 may communicate wirelessly (e.g., via WiFi, cellular, radio, etc.) with a transceiver that is hardwired (e.g., via a fiber optic cable, a CAT5 cable, etc.) to a computing device of network 102.

Content providers 104 may include one or more electronic devices representing advertisers, resource operators, business owners, or other entities using the services provided by content management system 110. In some implementations, content providers 104 may produce content items for presentation to user devices 108. In other implementations, content providers 104 may submit a content generation request to content management system 110 and content management system 110 may automatically generate a content item in response to the request. The content items may be stored in one or more data storage devices local to content providers 104, content management system 110, or data storage devices 112.

In some implementations, the content items may be advertisements. The advertisements may be display advertisements such as image advertisements, Flash® advertisements, video advertisements, text-based advertisements, or any combination thereof. In other implementations, the content items may include other types of content which serve various non-advertising purposes. The content items may be displayed in a content slot of resources 106 and presented (e.g., alongside other resource content) to user devices 108.

Content providers 104 may submit, to content management system 110, campaign parameters that are used to control the distribution of content items to user devices 108. The campaign parameters may include keywords associated with the content items, bids corresponding to the keywords, a content distribution budget, geographic limiters, or other criteria used by content management system 110 to determine when a content item may be presented to user devices 108.

Content providers 104 may access content management system 110 to monitor the performance of the content items that are distributed according to the established campaign parameters. For example, content providers 104 may submit a request to generate a comparative performance report to content management system 110. Content providers 104 may use the comparative report to evaluate the effectiveness of a content distribution strategy.

Still referring to FIG. 1, computer system 100 is shown to include resources 106. Resources 106 may include any type of information or data structure that can be provided over network 102. In some implementations, resources 106 may be identified by a resource address associated with each resource (e.g., a uniform resource locator (URL)). Resources 106 may include web pages, word processing documents, portable document format (PDF) documents, images, video, programming elements, interactive content, streaming video/audio sources, or other types of electronic information. Resources 106 may include content (e.g., words, phrases, images, sounds, etc.) having embedded information (e.g., meta-information embedded in hyperlinks) and/or embedded instructions. Embedded instructions may include computer-readable media (e.g., software code, JavaScript®, ECMAScript®, etc.) that is executed by user devices 108 (e.g., by a web browser running on user devices 108).

User devices 108 may include any number of user-operable electronic devices capable of receiving content (e.g., content items, resource content, etc.) via network 102. For example, user devices 108 may include desktop computers, laptop computers, smart phones, tablets, mobile communication devices, monitors, workstations, client terminals, entertainment consoles, or any other device capable of receiving electronic content. In some implementations, user devices 108 may include a user application (e.g., a web browser, a resource renderer, etc.) for converting electronic content into a comprehensible format (e.g., visual, aural, graphical, etc.). User devices 108 may further include a user interface element (e.g., an electronic display, a speaker, etc.) for presenting the received content to a user.

User devices 108 may submit a request for content from resources 106. Resources 106 may respond to a request for content by providing the requested content for presentation to user devices 108. In some implementations, the resource content may include a portion of resources 106 in which a content item or other sponsored content item can be presented. These portions of resources 106 may be referred to as content slots. Alternatively, other sponsored content or content items may be presented in a separate window (e.g., a pop up window) separate from the resource content. Resources 106 may populate these content slots by submitting a request for a content item to content management system 110.

Still referring to FIG. 1, computer system 100 is shown to include a content management system 110. Content management system 110 may receive a request for content items from resources 106 and select an eligible content item in response to the request. The selected eligible content item may be transmitted to resources 106 for presentation to user devices 108 along with the requested resource content. In some implementations, the selected content item may be delivered to the user devices 108 directly (e.g., without first transmitting the content item to resources 106) from content management system 110 or from data storage devices 112.

Content management system 110 may record performance data for each content item and use the recorded performance data to generate a comparative content performance report. The performance report may compare a content performance metric during a first time period with the same content performance metric during a second time period. In some implementations, the content performance metric may relate to a raw number of impressions, selections, and/or conversions for the distributed content items. In other implementations, the content performance metric may be a calculated value such as a keyword value, a total content distribution cost, a cost-per-click, an estimated profitability, or other measurement of content value.

Content management system 110 may generate the comparative performance report in response to a request from content providers 104. In generating the comparative performance report, content management system 110 may require a first time period and a second time period. Each time period may define a set of performance data for inclusion in the comparative report. For example, the first time period may specify a first date range (e.g., “last 7 days,” “last 14 days,” “last 30 days,” etc.) defining a first set of performance data. Similarly, the second time period may specify a second date range (e.g., “previous week,” “previous month,” etc.) defining a second set of performance data.

In some implementations, content management system 110 may receive a selection of the first time period from content providers 104 and may automatically determine the second time period such that the first and second time periods have matching seasonality characteristics. In other implementations, content management system 110 may receive both time periods from content providers 104. For example, content providers 104 may interact with content management system 110 via a web browser or other user interface capable of executing operating instructions. In some implementations, a content provider (e.g., a user) may specify the first time period and the web browser or other user interface may automatically determine the second time period. Both time periods may then be communicated to content management system 110.

Still referring to FIG. 1, computer system 100 is shown to include data storage devices 112. Data storage devices 112 may be any type of memory device capable of storing content items, content performance data, or other data used by content management system 110. Data storage devices 112 may include any type of non-volatile memory, media, or memory devices. For example, data storage devices 112 may include semiconductor memory devices (e.g., EPROM, EEPROM, flash memory devices, etc.) magnetic disks (e.g., internal hard disks, removable disks, etc.), magneto-optical disks, and/or CD-ROM and DVD-ROM disks. In some implementations, data storage devices 112 may be local to content management system 110 or content providers 104. In other implementations, data storage devices 112 may be connected with content management system 110 and content providers 104 via network 102.

Referring now to FIG. 2, a detailed block diagram of content management system 110 is shown, according to an exemplary embodiment. Content management system 110 may receive a selection of a first time period from a user device and automatically determine a second time period such that the first and second time periods have matching seasonality characteristics. Content management system may then retrieve a first and second data set defined by the first and second time periods and generate a comparative report based on such data. Content management system 110 is shown to include a communications interface 240 and a processing circuit 210.

Communications interface 240 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 240 may allow content management system 110 to communicate with network 102, content providers 104, resources 106, user devices 108, and/or data storage devices 112.

Still referring to FIG. 2, processing circuit 210 is shown to include a processor 220 and memory 230. Processor 220 may be implemented as a general purpose processor, an application specific integrated circuit (ASIC), one or more field programmable gate arrays (FPGAs), a CPU, a GPU, a group of processing components, or other suitable electronic processing components. Memory 230 may include one or more devices (e.g., RAM, ROM, Flash® memory, hard disk storage, etc.) for storing data and/or computer code for completing and/or facilitating the various processes, layers, and modules described in the present disclosure. Memory 230 may comprise volatile memory or non-volatile memory. Memory 230 may include database components, object code components, script components, or any other type of information structure for supporting the various activities and information structures described in the present disclosure.

In some implementations, memory 230 is communicably connected to processor 220 via processing circuit 210 and includes computer code (e.g., the modules stored in memory) for executing one or more processes described herein. Memory 230 is shown to include a content item module 232, a performance data module 234, a time period module 236, and a comparative report module 238.

Content item module 232 may receive a request for a content item (e.g., via communications interface 240) from resources 106. In some implementations, the request for content items may include characteristics of the content slots in which the content items will be displayed. For example, such characteristics may include the URL of the resource 106 on which the content slot is located, a display size of the content slot, a position of the content slot, and/or media types that are available for presentation in the content slot. If the content slot is located on a search results page, keywords associated with the search query may also be provided to content management system 110. These characteristics of the content slot may facilitate identification of content items that are relevant to resources 106 or to the search query.

Content item module 232 may select an eligible content item in response to the request received from resources 106. In some implementations, eligible content items may include content items having characteristics matching the characteristics of the content slots in which the content items are presented. For example, content item module 232 may select a content item having a display size which fits in a destination content slot. In some implementations, content item module 232 may resize a selected content item to fit a content slot or add additional visual content to the selected content item (e.g., padding, a border, etc.) based on the display size of the content item and the display size of the content slot.

In some implementations, content item module 232 may select a content item determined to be relevant to particular resource 106, user device 108, or search query. For example, content item module 232 may select a content item by comparing the keywords associated with each content item (e.g., specified by content providers 104, additional keywords extracted from the content item, etc.) with the keywords associated with the resource 106 requesting the content item. A topic or type of content included in resources 106 may be used to establish keywords for resources 106.

Content item module 232 may select a content item by comparing the keywords associated with each content item with information (e.g., profile data, user preferences, etc.) associated with a particular user device 108 requesting information from resource 106. In some implementations, content item module 232 may select a content item that does not match established user preferences if an insufficient number of preferred content items are available. In some implementations, content item module 232 may select a content item based on an established click-through-rate, a predicted click-through-rate, a bid price associated with each content item, or other relevant selection criteria.

The selected content item may be transmitted to resources 106 for presentation to user devices 108 along with the requested resource content. In some implementations, the selected content item may be delivered to the user devices 108 directly (e.g., without first transmitting the content item to resources 106) from content management system 110 or from data storage devices 112.

Still referring to FIG. 2, memory 230 is shown to include a performance data module 234. Performance data module 234 may record performance data for each content item (e.g., distributed content items and/or non-distributed content items). Performance data may include, for example, a number of times the content item was presented to user devices 108 (e.g., impressions), a number of times the content item was selected or clicked after being presented, and a number of conversions that have been attributed to the content item. Performance data may also include a cost-per-click, a total cost, or other cost measures for the content item. In some implementations, performance data may include contextual information such as the keyword triggering the presentation of the content item, a winning bid price for the keyword, and/or a value (e.g., a conversion value, a click-through-rate, etc.) associated with each keyword or content item.

In some implementations, performance data module 234 may identify a referring resource (e.g., a search results page, a web page, etc.), directing user devices 108 to resources 106. Performance data module 234 may identify a referring resource by executing code embedded in resources 106 and/or by information contained in a URL directing user devices 108 to resources 106. For example, user devices 108 may access resources 106 by selecting a link presented on a referring resource. This link can be associated with a URL that includes data (i.e., text) that uniquely identifies the resource from which user devices 108 are navigating to resource 106.

As one illustration, the hyperlink http://www.example.com/homepage/%affiliate_identifier%promotion1 may provide performance data module 234 with the information that a user device navigated to the “example.com” Internet resource from a resource associated with the affiliate identifier number “affiliate_identifier” specified in the URL. Furthermore, the hyperlink may provide performance data module 234 with the information that the user device was directed to the “example.com” Internet as part of a content distribution campaign associated with the promotion code “promotion1.” The user interaction data for this interaction (i.e., the selection of the link) may be stored in data storage devices 112 and used, as described below, to facilitate performance reporting and visualizing the flow of traffic in computer system 100.

In some implementations, performance data module 234 may collect performance information relating to user devices 108 to which the distributed content items are presented. Such information may include other content items presented to the same user device, user content preferences, geographic information, or other profile information associated with user devices 108. For situations in which content management system 110 collects personal information about users or makes use of personal information, the users may be provided with an opportunity to control whether programs or features collect user information (e.g., information about a user's social network, social actions or activities, profession, a user's preferences, or a user's current location), or to control whether and/or how to receive content from content management system 110 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by content management system 110.

Performance data module 234 may record a time associated with each recorded event. For example, performance data module 234 may record a time at which a selected content item is presented to a user device 108, a time at which the content item is clicked by a user, and/or a time at which a conversion attributed to a particular impression of the content item event occurs. The performance data may be stored in one or more data storage devices. In some implementations, the performance data may be stored locally within memory 230. In other implementations, the performance data may be stored in a remote data storage device (e.g., data storage devices 112) accessible via network 102.

Still referring to FIG. 2, memory 230 is shown to include a time period module 236. Time period module 236 may automatically select a time period defining a set of performance data for inclusion in the comparative content performance report. Although time period module 236 is shown as a component of content management system 110, in some implementations, time period module 232 may be a component of content providers 104 or user devices 108. For example, a content provider may request a comparative content performance report using a user device (e.g., a personal computer, laptop, tablet, smart phone, client terminal, etc.) in communication with content management system 110 via network 102. The user device may include a web browser or other user interface capable of storing and executing operating instructions including time period module 236. Accordingly, the time period selection process may be performed by content management system 110, content providers 104, or a combination of both.

Time period selection module 236 may perform a time period determination process to determine a time period for inclusion in the comparative performance report. The time period selection process may include receiving a selection of a first time period from a user device, identifying a first seasonality characteristic of the first time period, and determining a second time period such that the second time period has a second seasonality characteristic matching the first seasonality characteristic.

The first seasonality characteristic and the second seasonality characteristic may be time-based qualities of the first and second time periods (e.g., a time of day, a day of the week, a date, a month, a year, etc.). For example, if the first time period defines a seven day period beginning on a Monday, time period module 236 may determine the second time period such that the second time period also defines a seven day period beginning on a Monday. As another example, if the first time period defines a thirty day period beginning on the Jun. 1, 2012, time period module 236 may determine the second time period such that the second time period defines a thirty day period beginning on May 1, 2012. Both time periods share a seasonality characteristic in that they both begin on the first day of a month. Alternatively, time period selection module 236 may determine the second time period such that the second time period defines a thirty day period beginning on Jun. 1, 2011. Both time periods share a seasonality characteristic in that they both begin on June 1.

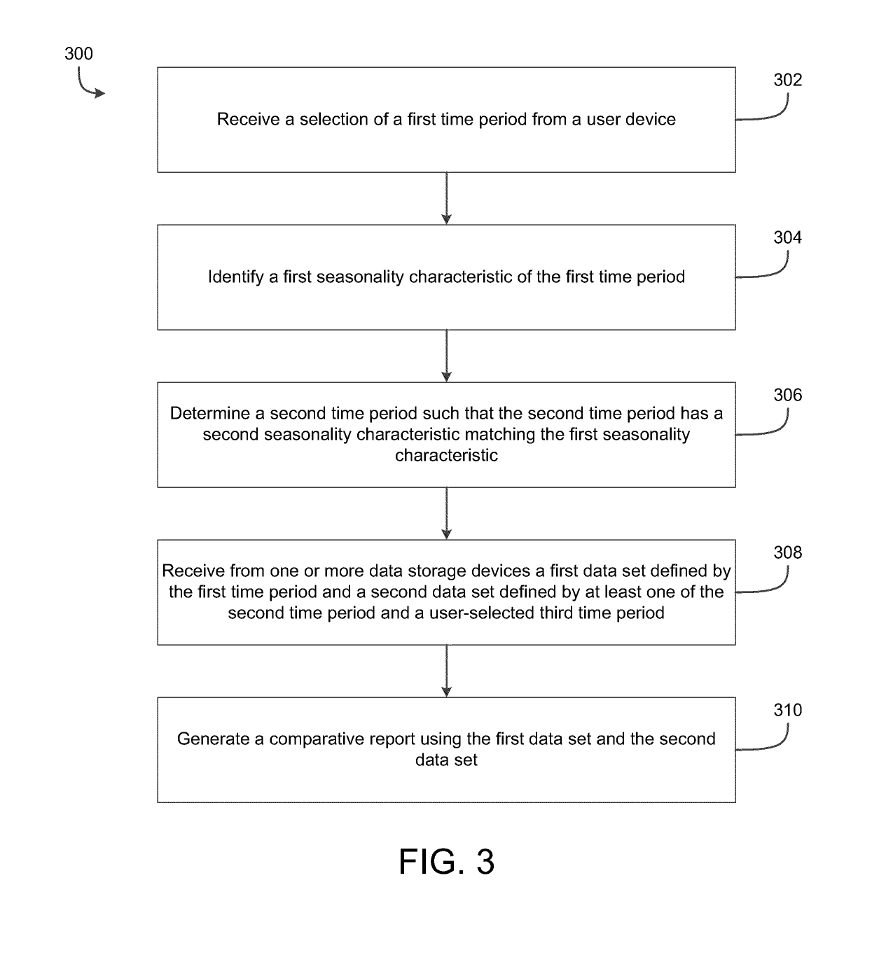

In some implementations, time period module 236 may provide a user (e.g., a content provider) with an option to prioritize various seasonality characteristics or to choose between several possibilities for the second time period. In some implementations, time period module 236 may generate a list of selectable options for the second time period. Each selectable option may include a description of the seasonality characteristic used to determine the second time period. The time period selection process is described in greater detail in reference to FIG. 3. Time period module 236 may output a first and second time period for use in generating the comparative performance report.

Still referring to FIG. 2, memory 230 is shown to include a comparative report module 238. Comparative report module 238 may receive the first and second time periods from time period module 236. The first time period may define a first data set and the second time period may define a second data set. Comparative report module 238 may use the first and second time periods to identify and retrieve the first and second data sets.

Comparative report module 238 may receive an input from a user device (e.g., a device used by content providers 104) specifying a performance metric. In some implementations, the content performance metric may relate to a raw number of impressions, selections, and/or conversions for the distributed content items. In other implementations, the content performance metric may be a calculated value such as a keyword value, a total content distribution cost, a cost-per-click, an estimated profitability, or other measurement of content value. In further implementations, the performance metric may relate to a number of unique visitors (e.g., user devices 108) to a monitored resource (e.g., a website traffic analysis).

Comparative report module 238 may use the first data set, the second data set, and the performance metric to generate a comparative performance report. The performance report may compare the selected content performance metric during the first time period with the same content performance metric during the second time period. The performance report may be a historical report based on past performance data or a performance estimate using estimated performance data (e.g., a predicted click-through-rate, estimated conversion, etc.).

Referring now to FIG. 3, a flowchart of a process 300 for generating a time-based comparative report is shown, according to a described implementation. Process 300 may be performed by content management system 110 or by a user device. The user device may perform process 300 by executing operating instructions included presented to the user device by content management system 110. In brief overview, process 300 is shown to include receiving a selection of a first time period from a user device (step 302), identifying a first seasonality characteristic of the first time period (step 304), determining a second time period such that the second time period has a second seasonality characteristic matching the first seasonality characteristic (step 306), receiving from one or more data storage devices a first data set defined by the first time period and a second data set defined by at least one of the second time period and a user-selected third time period (step 308), and generating a comparative report using the first data set and the second data set (step 310).

Still referring to FIG. 3, and in greater detail, process 300 is shown to include receiving a selection of a first time period from a user device (step 302). The first time period may be a range of dates (e.g., May 27-June 26), hours (e.g., 3:00 P.M.-6:00 P.M.), months (e.g., January 2013-March 2013), years, or any other measurement of time. In some implementations, the first time period may be specified as a relative range (e.g., last 7 days, last 30 days, last 6 hours, etc.) looking backward from the time at which the first time period is selected. For example, a present date of “Jul. 15, 2013” with a “last year” qualifier would define the first time period as a range of dates from Jul. 15, 2012 through Jul. 15, 2013.

In some implementations, the first time period may be a single day, month, or other unitary time period. Such a selection may implicitly select the all times occurring during the selected day, month, or other unitary time period. The selection of a unitary time period may be specified in absolute terms (e.g., May 29, 2012, May 2012, etc.) or relative terms (e.g., today, yesterday, last week, last month, etc.).

The selection of the first time period may be a user-specified time period (e.g., manually typed or otherwise entered into the user device) or a selection of a time period from a list of selectable options. For example, in some implementations, time period module 236 may cause a list of selectable time period options to be presented to a user device and/or displayed visually by the user device. A user may select the first time period by clicking or otherwise choosing a time period from the presented list.

Still referring to FIG. 3, process 300 is shown to further include identifying a first seasonality characteristic of the first time period (step 304). The first seasonality characteristic may be a time-based quality of the first time period. For example, the first seasonality characteristic may relate at least one of: a time of day, a day of the week, a date, a month, and a year. In some implementations, the first seasonality characteristic describes a beginning of the first time period (e.g., beginning on a Monday, beginning on the first day of a month, etc.).

In some implementations, step 304 includes identifying multiple seasonality characteristics of the first time period. For example, a selection of a first time period of Sunday, May 27-Saturday, June 26 may have a seasonality characteristic of “beginning on a Sunday” and another seasonality characteristic of “includes 31 days.” The first time period may have yet another seasonality characteristic of “includes 9 weekend days” or “includes 22 weekdays.” Any number and/or type of seasonality characteristics may be identified for the first time period.

In some implementations, step 304 may include assigning a weight or ranking to a plurality of identified seasonality characteristics. The weights may be specified by a user, automatically determined, or received from another data source. In some implementations, the weights may be based on a history of performance data for a given performance metric. For example, seasonality characteristics having a higher correlation with the selected performance metric may be assigned a heaver weight.

Still referring to FIG. 3, process 300 is shown to further include determining a second time period such that the second time period has a second seasonality characteristic matching the first seasonality characteristic (step 306). Advantageously, step 306 may ensure that the second time period and the first time period have matching seasonality characteristics to avoid seasonality-based misreads in the comparative content performance report.

For example, a content provider may routinely experience a higher number of conversion events (e.g., online product sales or other events satisfying conversion criteria) during the weekend than during the week. Accordingly, a report comparing the number of conversion events during a Friday-Sunday period with the number of conversion events during a Monday-Wednesday period may be misleading regarding the effectiveness of a newly-implemented content distribution strategy. The content provider may be misled to believe that the newly-implemented content distribution strategy is not as effective as the previous strategy due to the lower number of conversion events that routinely occur during a Monday-Wednesday period. Advantageously, the second time period determined during step 306 may be a Monday-Wednesday period from a previous week such that the first and second time periods share the “begins on a Monday” seasonality characteristic.

In some embodiments, step 306 may include receiving a user-defined third time period and adjusting the third time period such that a seasonality characteristic of the adjusted third time period matches the seasonality characteristic of the first time period. The adjusted third time period may be used as the second time period. A selection of the third time period may be made (e.g., by a user) by manually typing or otherwise entering the third time period into the user device. Alternatively, the selection of the third time period may be made by a user choosing the third time period from a list of selectable options. For example, in some implementations, time period module 236 may cause a list of selectable time period options to be presented to a user device and/or displayed visually by the user device. A user may select the third time period by clicking or otherwise choosing a time period from the presented list.

Adjusting the third time period may include shifting the third time period by a fixed number of days, weeks, months, hours, or any other unit of time. The fixed number may be determined by comparing a seasonality characteristic of the third time period with a seasonality characteristic of the first time period. For example, if the first time period begins on a Monday and the third time period begins on a Wednesday, the third time period may be shifted by −2 days or +5 days such that both time periods begin on a Monday. The shifting may be positive (e.g., +5 days) or negative (e.g., −2 days). In some embodiments, the direction of the shift (e.g., positive or negative) may be the direction which results in a lower absolute value for the duration of the shift. For example, if given a choice to shift the third time period by −2 days or +5 days, the shift may be performed in the negative direction because the absolute value of −2 days is less than the absolute value of +5 days (e.g., |−2 days|<|+5 days|).

In some embodiments, the direction of the shift may be reversed if the selected shift direction would result in an overlap between the first time period and the second time period. In some embodiments, the absolute value of the duration of the shift may be minimized. For example, a shift of −2 days may be preferable over a shift of −9 days because the absolute value of −2 days is less than the absolute value of −9 days (e.g., |−2 days|<|−9 days|). In some embodiments, external data (e.g., weather data, stock price, calendar data, etc.), other metrics, or a moving average of external data and/or other metrics may be used to provide additional context in determining a duration of the shift.

In some implementations, step 306 may include determining a second time period based on a plurality of identified seasonality characteristics. The second time period may be determined by selecting the second time period from a set of potential second time periods. Each of the potential second time periods may be assigned a seasonality score based on the number and weight of seasonality characteristics shared by each of the potential second time periods and the first time period. The potential second time period having the highest seasonality score may be selected as the second time period. In some embodiments, the seasonality score may be used to determine a shift direction for the user-specified third time period.

In some embodiments, the seasonality characteristics may be ranked from most important to least important. The most important seasonality characteristic may be used to determine a set of potential second time periods having equivalent “most important seasonality characteristics.” The other seasonality characteristics may be used to select one of the potential second time periods from the set of potential second time periods. For example, if the first time period ranges from Monday Apr. 1, 2013-Friday Apr. 5, 2013, the first time period may have the following seasonality characteristics ordered from most important to least important: (1) five day duration, (2) begins on a Monday, (3) begins on the first of a month, and (4) occurs within calendar year 2013. This ordering and identification of seasonality characteristics is merely exemplary and may be different in various embodiments in which the seasonality characteristics have different weights and/or importance rankings.

The most important seasonality characteristic (e.g., five day duration) may define many potential second time periods having a duration of five days. Each of these potential second time periods has an equivalent first seasonality characteristic with the first time period. However, by considering the second most important seasonality characteristic (e.g., begins on a Monday), the set of potential second time periods may be reduced to only those which begin on a Monday. By considering the third most important seasonality characteristic (e.g., begins on the first of a month), the set of potential second time periods may be reduced further to only those which begin on the first of a month. By considering the fourth most important seasonality characteristic (e.g. occurs within calendar year 2013), the set of potential second time periods may be reduced further to only those which occur within calendar year 2013.

In some implementations, step 306 may include presenting a plurality of potential second time periods to the user device. Each potential second time period may be presented as a selectable option. The selectable option may include a description of the seasonality characteristic(s) used to determine the potential second time period and/or the range defined by the potential second time period.

Still referring to FIG. 3, process 300 is shown to further include receiving from one or more data storage devices a first data set defined by the first time period and a second data set defined by at least one of the second time period and a user-selected third time period (step 308). Step 308 may include retrieving performance data relevant a given performance metric from a data storage device such as data storage devices 112. For example, if the performance metric is “number of conversion events,” step 308 may include retrieving data representing the number of conversion events occurring during each discrete time interval during the first and second time periods.

In some implementations, the relevant data sets may include performance data recorded at times outside the first and second time periods. For example, if the performance metric is “keyword profitability,” step 308 may include retrieving data representing an amount spent by the content provider on various keyword bids during the first and second time periods as well as the number and value of conversion events attributable to such keyword bids. Although the attributable conversion events may occur outside of the first or second time periods, the fact that such conversion events are attributable to a keyword bid occurring during the first or second time periods may cause the conversion events to be relevant to the “keyword profitability” metric.

In some implementations, the first data set may be defined by the first time period and the second data set may be defined by the second time period. In other implementations, the second data set may be defined by a user-specified third time period. In some implementations, process 300 may include providing an option to use either the second time period or the third time period for defining the second data set. The option may be provided as a global option (e.g., a configuration setting, an overriding preference, etc.) or as a selectable option each time a choice between the second time period and third time period is relevant.

A selection of the third time period may be made (e.g., by a user) by manually typing or otherwise entering the third time period into the user device. Alternatively, the selection of the third time period may be made by a user choosing the third time period from a list of selectable options. For example, in some implementations, time period module 236 may cause a list of selectable time period options to be presented to a user device and/or displayed visually by the user device. A user may select the third time period by clicking or otherwise choosing a time period from the presented list.

In some implementations, process 300 may include identifying a third seasonality characteristic of the third time period. The third seasonality characteristic may be identified in response to receiving a selection of the third time period. Process 300 may further include providing a notification for display via the user device in response to the third seasonality characteristic not matching the first seasonality characteristic. The notification may alert or inform the user that the selection of the third time period may result in a seasonality-based mislead in the comparative performance report. In some implementations, the notification may include a display (e.g., a suggestion, a preview, etc.) of the second time period along with an option to use the second time period instead of the third time period for defining the second data set.

Still referring to FIG. 3, process 300 is shown to further include generating a comparative report using the first data set and the second data set (step 310). Step 310 may include determining one or more calculated values based on the performance data in the first and second data sets. The first and second data sets may be used to determine a value of one or more content performance metrics during the first time period and the second time period. In some implementations, the content performance metric may relate to a raw number of impressions, selections, and/or conversions for the distributed content items. In other implementations, the content performance metric may be a calculated value such as a keyword value, a total content distribution cost, a cost-per-click, an estimated profitability, or other measurement of content value. In further implementations, the performance metric may relate to a number of unique visitors to a monitored resource.

The comparative performance report may compare the selected content performance metric during the first time period with the same content performance metric during the second time period. The performance report may be a historical report based on past performance data (e.g., if the first or second time periods define an expired time period) or a performance estimate using estimated performance data (e.g., if the first or second time periods define an upcoming time period). The comparative report may be presented to a user device as a chart, graph, or other visual comparison.

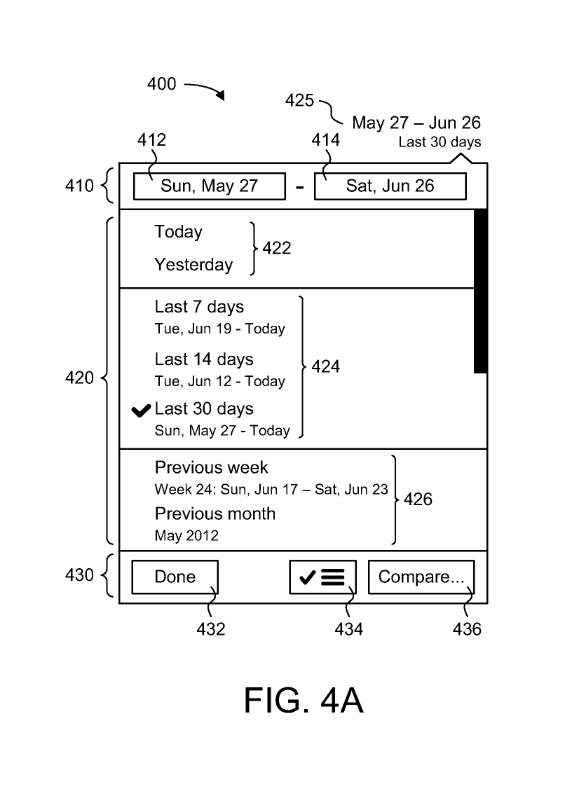

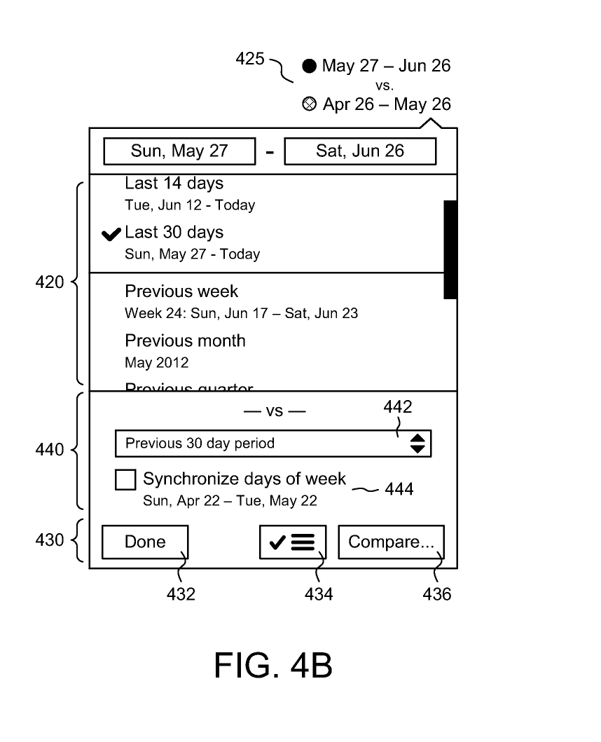

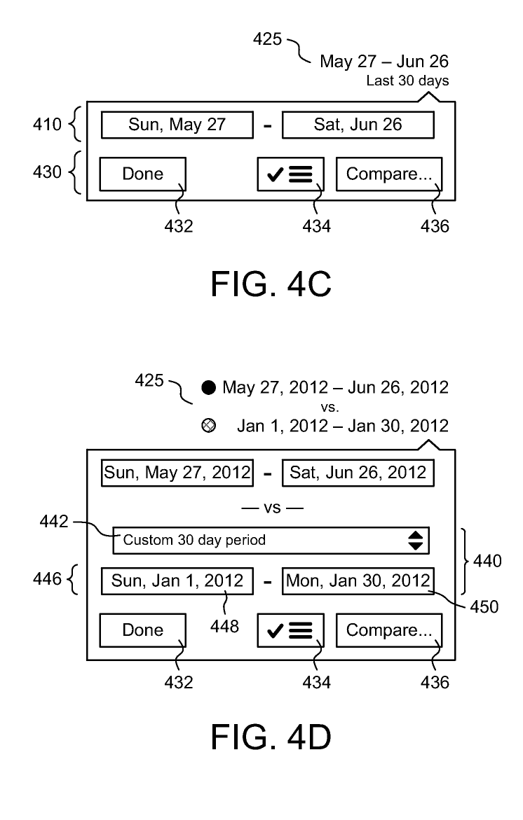

Referring now to FIGS. 4A-4D, an illustration of a user interface 400 for defining one or more time periods is shown, according to a described implementation. User interface 400 may be presented to a user device for facilitating the selection or customized definition of the first time period, the second time period, and/or the third time period.

Referring specifically to FIG. 4A, interface 400 is shown to include a custom time period input bar 410. Input bar 410 may be used to enter (e.g., via a keyboard or other user input device) a customized range for the first time period. The customized range may be a customized date range (e.g., May 27-June 26), a customized time range (e.g., 3:00 P.M.-5:00 P.M.), a customized month range (e.g., May 2012-April 2013), or another customized range using any other time measurement unit. Input bar 410 is shown having a first field 412 and a second field 414. Field 412 may be used to enter a customized start date for the first time period and field 414 may be used to enter a customized end date for the first time period.

Interface 400 is further shown to include a quick pick list 420. List 420 may be used as an alternative to time period input bar 410 for defining the first time period. List 420 is shown to include single day selection options 422 and date range selection options 424,426. Single day selection options 422 may be used to select a single day (e.g., today, yesterday, etc.) as the first time period. Date range selection options 424,426 may be used to select a range of dates as the first time period. Options 424 present a range of dates ending with the current date (e.g., last 7 days, last 14 days, last 30 days, etc.) whereas options 426 present a range of dates ending prior to the current date (e.g., previous week, previous month, etc.).

Quick pick list 420 may include any number or type of selection options in addition to or in place of the options shown. For example, date range selection options 424 may include additional date range options such as “last two months,” “last year,” “last quarter,” “last two years,” etc. Date range selection options 426 may include additional date range options such as “previous quarter,” “previous year,” “previous two years,” etc. Quick pick list 420 may further include several “to date” options (e.g., week to date, month to date, quarter to date, year to date, etc.) specifying a continuously increasing time period beginning at the start of the listed time measurement unit (e.g., the current week, month, quarter, year, etc.) and ending at the current date.

In some implementations, a selection of any of quick pick options 420 may cause a check mark to be displayed next to the selected option. The check mark may indicate to a user that the checked time period has been selected. Selecting any of quick pick options 420 may also cause the date range displayed in input bar 410 to change to the checked option. In some implementations, interface 400 may include a selection indicator 425. Indicator 425 may display the time period selected by either input bar 410 or quick pick list 420. In some implementations, quick pick list 420 and/or selection indicator 425 may include a written description of the corresponding date range in addition to a numerically defined range. For example, the date range “May 27-June 26” in indicator 425 is shown described in relative terms as “last 30 days.”

Interface 400 is shown to further include an icon bar 430. Icon bar 430 may include one or more selectable icons for reconfiguring or confirming a selection made via interface 400. Icon bar 430 is shown to include a “Done” icon 432, a quick pick icon 434, and a “Compare” icon 436. Selecting icon 432 may confirm the usage of the selected time periods for defining the first and second data sets used in the comparative performance report.

Selecting quick pick icon 434 may cause interface 400 to hide or display quick pick list 420. For example, when interface 400 is in the default state shown in FIG. 4A, clicking icon 434 may transition interface 400 between a default state (shown in FIG. 4A) and a compact state (shown in FIG. 4C). In the compact state shown in FIG. 4C, only input bar 410, selection indicator 425, and icon bar 430 are displayed. When interface 400 is in the default compare state shown in FIG. 4B, clicking icon 434 may cause interface 400 to transition between the default compare state (shown in FIG. 4B) and a compact compare state (shown in FIG. 4D). Clicking icon 434 again may cause quick pick list 420 to reappear.

Referring now to FIG. 4B, selecting “Compare” icon 436 may cause interface 400 to display a comparison window 440. Window 440 may be used to confirm a determination of the second time period (e.g., having a matching seasonality characteristic with the first time period) or to select a user-defined third time period. Window 440 is shown to include the text “vs.” indicating that the time period selected in comparison window 440 (e.g., the second time period or the third time period) will be compared against the previously selected time period (e.g., the first time period).

Window 440 is shown to further include a seasonality characteristic check box 444. Check box 444 may present a user with an option to use either the automatically-determined second time period (e.g., having a matching seasonality characteristic with the first time period) or a user-defined third time period. The textual description displayed alongside check box 444 may describe the seasonality characteristic used to determine the second time period. For example, the text “Synchronize days of the week” may indicate that the seasonality characteristic used to determine the second time period relates to a day of the week (e.g., Monday, Saturday, etc.). In other implementations, the text may display other instructive descriptions based on the matching seasonality characteristic. In some implementations, check box 444 may include a preview of the second time period.

Window 440 is further shown to include a drop-down selection box 442. Drop-down box 442 may include selection options such as “previous 7 day period,” “previous 30 day period,” “previous quarter,” and “previous year.” The selection options presented via drop-down box 442 may include one or more automatically determined time periods as a potential candidate for the second time period. The selection options presented via drop-down box 442 may define time periods having different durations or time periods having different seasonality characteristics in common with the first time period. In some implementations, each of the options presented via drop-down box 442 may include a description of the shared seasonality characteristic.

Referring now to FIG. 4D, drop-down selection box 442 may include an option permitting a user to select a customized time period (e.g., the third time period). For example, drop-down selection box 442 is shown to include the option “Custom 30 day period.” Selecting the customized time period option via drop-down box 442 may cause interface 400 to display a custom time period input bar 446.

Input bar 446 may be similar or the same as input bar 410. For example, input bar 446 may be used to enter (e.g., via a keyboard or other user input device) a customized range for the third time period. The customized range may be a customized date range (e.g., May 27-June 26), a customized time range (e.g., 3:00 P.M.-5:00 P.M.), a customized month range (e.g., May 2012-April 2013), or another customized range using any other time measurement unit. Input bar 446 is shown having a first field 448 and a second field 450. Field 448 may be used to enter a customized start date for the third time period and field 450 may be used to enter a customized end date for the first time period.

In some implementations, upon receiving a selection of the third time period, user interface 400 may display a notification that the third time period does not share an important (e.g., highly weighted, highly ranked, etc.) seasonality characteristic with the first time period. A user may be presented with the notification and with an option to use the second time period instead of the third time period for defining the second data set. In some embodiments, the second time period presented to the user may be determined based on the seasonality characteristic of the first time period as well as the user selection of the third time period.

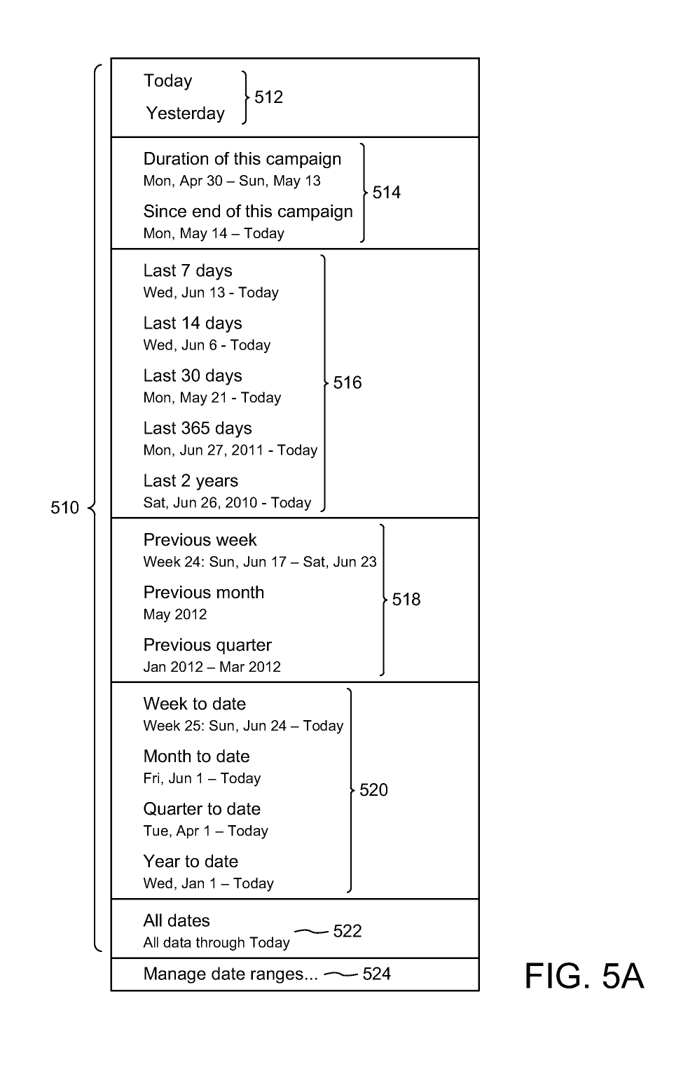

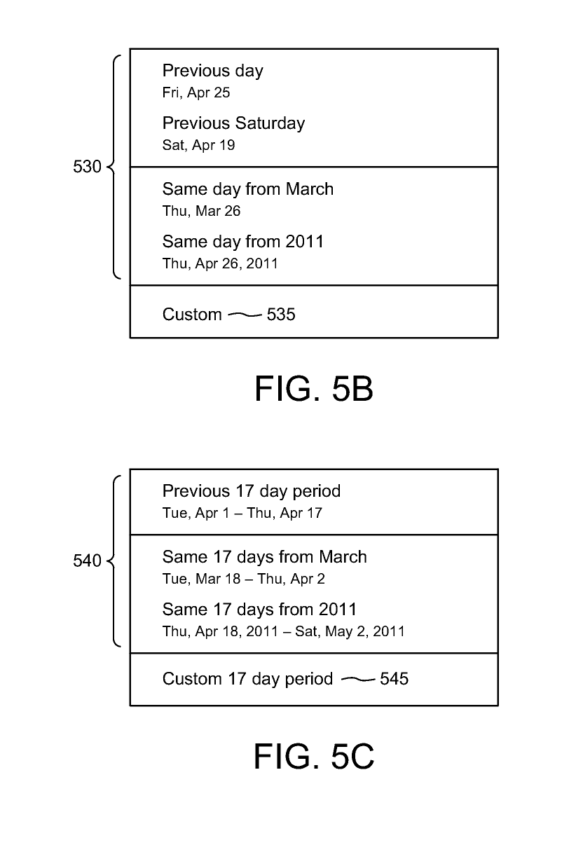

Referring now to FIGS. 5A-5C, an illustration of another user interface 500 for defining one or more time periods is shown, according to a described implementation. Referring specifically to FIG. 5A, interface 500 is shown to include a list of selection options 510. Selection options 510 may be selected (e.g., clicked or otherwise selected via a user input device) to define the first time period. Selection options 510 are shown to include single day options 512 (e.g., today, yesterday, etc.), campaign-relative options 514, fixed range selection options 516 and 518, “to date” selection options 520, all dates selection option 522, and a custom time period selection option 524.

Campaign-relative options 514 may define a time period relative to a start or end date of a selected content item distribution strategy (e.g., a selected ad campaign). Selectable options are shown to include “duration of this campaign” and “since end of this campaign.” The “duration of this campaign” option may be selected to define a time period corresponding to the duration of a selected campaign. The selected campaign may be a current campaign (e.g., currently in progress) or a historical campaign (e.g., currently expired). The “since end of this campaign” option may be selected to define a time period beginning at the end of the selected campaign and ending at the current time or date.

Fixed range selection options 516,518 may be used to select a range of dates as the first time period. Options 516 present a range of dates ending with the current date (e.g., last 7 days, last 14 days, last 30 days, etc.) whereas options 518 present a range of dates ending prior to the current date (e.g., previous week, previous month, etc.). Selection options 520 are shown to include several “to date” options (e.g., week to date, month to date, quarter to date, year to date, etc.) specifying a continuously increasing time period beginning at the start of the listed time measurement unit (e.g., the current week, month, quarter, year, etc.) and ending at the current date. “All dates” selection option 522 may be selected to define a time period including all previously recorded performance data. Custom time period selection option 524 may be selected to define the first time period using customized definition criteria.

Referring now to FIG. 5B, interface 500 is shown to include several single day selection options 530 for defining the second time period. Selection options 530 may be displayed in response to a selection of single day options 512 (shown in FIG. 5A) for the first time period. In some implementations, selection options 530 may include various single day time periods corresponding to various seasonality characteristics of the first time period. For example, the “previous Saturday” selection option may define a day sharing a “day of the week” seasonality characteristic with the first time period (e.g., both days are Saturdays). The “same day from March” selection option may define a day sharing a “day of the month” seasonality characteristic with the first time period (e.g., both days are the 26th day of the month). The “same day from 2011” selection option may define a day sharing a “date of the year” seasonality characteristic with the first time period (e.g., both days are April 26th). Any number of single day selection options may be present in addition to or in place of the selection options 530 shown in FIG. 5B.

Referring now to FIG. 5C, interface 500 is shown to include several multiple day selection options 540 for defining the second time period. Selection options 540 may be displayed in response to a selection of multiple day selection options 516-522 (shown in FIG. 5A) for the first time period. In some implementations, selection options 540 may include various multiple day time periods corresponding to various seasonality characteristics of the first time period. For example, the “same 17 days from March” selection option may define a time period sharing a “days of the month” seasonality characteristic with the first time period (e.g., both time periods begin on the 18th day of a month). The “same 17 days from 2011” selection option may define a time period sharing a “dates of the year” seasonality characteristic with the first time period (e.g., both time periods begin on April 18th). Any number of single day selection options may be present in addition to or in place of the selection options 540 shown in FIG. 5C.

Referring now to FIGS. 5B and 5C, interface 500 is shown to further include custom time period selection options 535 and 545. Selecting either of custom time period selection options 535,545 may allow a user to enter a user-defined, customized time period (e.g., the third time period). Selection option 535 may be selected to enter a customized single day time period whereas selection option 545 may be selected to enter a customized multiple day time period.

In some implementations, upon receiving a selection of the third time period, user interface 500 may display a notification that the third time period does not share an important (e.g., highly weighted, highly ranked, etc.) seasonality characteristic with the first time period. A user may be presented with the notification and with an option to use the second time period instead of the third time period for defining the second data set. In some embodiments, the second time period presented to the user may be determined based on the seasonality characteristic of the first time period as well as the user selection of the third time period.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An automated computer-implemented method for generating a time-based comparative report, the method comprising:
receiving, at a processing circuit, a selection of a first time period from a user device;
identifying, by the processing circuit, a first seasonality characteristic of the first time period, wherein the first seasonality characteristic describes a beginning of the first time period;
determining, by the processing circuit, a second time period such that the second time period has a second seasonality characteristic matching the first seasonality characteristic, wherein determining the second time period comprises:
receiving a selection of a third time period from the user device;
identifying a third seasonality characteristic of the third time period, wherein the third seasonality characteristic describes a beginning of the third time period;
calculating a difference in time between the third seasonality characteristic and the first seasonality characteristic; and
generating the second time period by shifting the third time period forward or backward in time by a magnitude of the difference;
retrieving, by the processing circuit from one or more data storage devices, a first set of performance data collected during the first time period and a second set of performance data collected during at least one of the second time period and the user-selected third time period;
calculating, by the processing circuit, a first performance metric using the first set of performance data and a second performance metric using the second set of performance data; and
generating, by the processing circuit, a comparative performance report comparing the first performance metric and the second performance metric;
wherein the processing circuit automatically determines the second time period, retrieves the sets of performance data, calculates the performance metrics, and generates the comparative performance report in real-time in response to a request from the user device.

2. The method of claim 1, wherein the first seasonality characteristic and the second seasonality characteristic are time-based qualities of the first and second time periods.

3. The method of claim 1, wherein the first seasonality characteristic and the second seasonality characteristic relate to at least one of: a time of day, a day of the week, a date, a month, and a year.

4. The method of claim 1, wherein the first seasonality characteristic and the second seasonality characteristic describe a beginning of the first and second time periods.

5. The method of claim 1, further comprising:
providing an option to use either the second time period or the third time period for defining the second data set;
receiving a selection of the third time period from a user device;
identifying a third seasonality characteristic of the third time period; and
providing a notification for display via the user device in response to the third seasonality characteristic not matching the first seasonality characteristic.

6. The method of claim 1, further comprising:
receiving a selection of the third time period from a user device;
determining the second time period based on the third time period and the seasonality characteristic of the first time period;
providing a selectable preview of the second time period for display via the user device; and
using the second time period for defining the second data set in response to a selection of the selectable preview of the second time period.

7. The method of claim 6, wherein the selectable preview of the second time period includes a description of the seasonality characteristic of the second time period.

8. The method of claim 1, further comprising:
generating a list of selectable time periods; and
providing the list of selectable time periods for display via the user device,
wherein at least one of the first time period, the second time period, and the third time period are selected from the list of selectable time periods.

9. The method of claim 1, wherein the first time period defines a particular day and the second time period defines a matching day from a previous week, a matching day from a previous month, or a matching day from a previous year.

10. The method of claim 1, wherein the first time period defines a range of days and the second time period defines a matching range of days from a previous week, a matching range of days from a previous month, or a matching range of days from a previous year.

11. A content management system comprising:
a communications interface configured to receive a selection of a first time period from a user device;
a processing circuit configured to identify a first seasonality characteristic of the first time period and to determine a second time period such that the second time period has a second seasonality characteristic matching the first seasonality characteristic, wherein the first seasonality characteristic describes a beginning of the first time period and wherein determining the second time period comprises:
receiving a selection of a third time period from the user device;
identifying a third seasonality characteristic of the third time period, wherein the third seasonality characteristic describes a beginning of the third time period;
calculating a difference in time between the third seasonality characteristic and the first seasonality characteristic; and
generating the second time period by shifting the third time period forward or backward in time by a magnitude of the difference;
wherein the processing circuit is further configured to retrieve, from one or more data storage devices, a first set of performance data collected during the first time period and a second set of performance data collected during at least one of the second time period and the user-selected third time period;
wherein the processing circuit is configured to calculate a first performance metric using the first set of performance data and a second performance metric using the second set of performance data;
wherein the processing circuit is further configured to generate a comparative performance report comparing the first performance metric and the second performance metric;
wherein the processing circuit automatically determines the second time period, retrieves the sets of performance data, calculates the performance metrics, and generates the comparative performance report in real-time in response to a request from the user device.

12. The content management system of claim 11, wherein the first seasonality characteristic and the second seasonality characteristic are time-based qualities of the first and second time periods.

13. The content management system of claim 11, wherein the first seasonality characteristic and the second seasonality characteristic relate to at least one of: a time of day, a day of the week, a date, a month, and a year.

14. The content management system of claim 11, wherein the communications interface is further configured to receive a selection of the third time period from a user device,
wherein the processing circuit is further configured to:
provide an option to use either the second time period or the third time period for defining the second data set;
identify a third seasonality characteristic of the third time period; and
provide a notification for display via the user device in response to the third seasonality characteristic not matching the first seasonality characteristic.

15. The content management system of claim 11, wherein the communications interface is further configured to receive a selection of the third time period from a user device,
wherein the processing circuit is further configured to:
determine the second time period based on the third time period and the seasonality characteristic of the first time period;
provide a selectable preview of the second time period for display via the user device; and
use the second time period for defining the second data set in response to a selection of the selectable preview of the second time period.

16. The content management system of claim 15, wherein the selectable preview of the second time period includes a description of the seasonality characteristic of the second time period.

17. The content management system of claim 11, wherein the processing circuit is further configured to:
generate a list of selectable time periods; and
provide the list of selectable time periods for display via the user device,
wherein at least one of the first time period, the second time period, and the third time period are selected from the list of selectable time periods.

18. The content management system of claim 11, wherein the first time period defines a particular day and the second time period defines a matching day from a previous week, a matching day from a previous month, or a matching day from a previous year.

19. The content management system of claim 11, wherein the first time period defines a range of days and the second time period defines a matching range of days from a previous week, a matching range of days from a previous month, or a matching range of days from a previous year.

20. One or more non-transitory computer-readable media having instructions stored therein, the instructions being executable by one or more processors to cause the one or more processors to perform operations comprising:
receiving a selection of a first time period from a user device, wherein the first seasonality characteristic describes a beginning of the first time period;
identifying a first seasonality characteristic of the first time period;
determining a second time period such that the second time period has a second seasonality characteristic matching the first seasonality characteristic, wherein determining the second time period comprises:
receiving a selection of a third time period from the user device;
identifying a third seasonality characteristic of the third time period, wherein the third seasonality characteristic describes a beginning of the third time period;
calculating a difference in time between the third seasonality characteristic and the first seasonality characteristic; and
generating the second time period by shifting the third time period forward or backward in time by a magnitude of the difference;
retrieving, from one or more data storage devices, a first set of performance data collected during the first time period and a second set of performance data collected during at least one of the second time period and the user-selected third time period;
calculating a first performance metric using the first set of performance data and a second performance metric using the second set of performance data; and
generating a comparative performance report comparing the first performance metric and the second performance metric;
wherein the one or more processors automatically determine the second time period, retrieve the sets of performance data, calculate the performance metrics, and generate the comparative performance report in real-time in response to a request from the user device.
